(19) United States
(12) Patent Application Publication
(10) Pub. No.: US 2021/0242708 A1
(43) Pub. Date: Aug. 5, 2021

(54) HYBRID POWER SYSTEM AND CONTROL METHOD

(71) Applicant: PEGASUS AERONAUTICS CORPORATION, Waterloo (CA)

(72) Inventors: Jonathan BISKEY, Waterloo (CA); Ryan COCKTON, Waterloo (CA); Carl ENGELMANN, Waterloo (CA); Joseph KINSELLA, Waterloo (CA); Matthew MCROBERTS, Waterloo (CA)

(21) Appl. No.: 17/052,494

(22) PCT Filed: May 9, 2019
(86) PCT No.: PCT/IB2019/053832

§ 371 Date: Nov. 2, 2020

Related U.S. Application Data
(60) Provisional application No. 62/669,047, filed on May 9, 2018.

(51) Int. Cl. H02J 7/34; F02B 63/04; H02K 7/18

(52) U.S. Cl. CPC H02J 7/34; H02K 7/1815; F02B 63/042

(57) ABSTRACT

A novel hybrid power system and control method. The system and method controls the operation of each of a prime mover, such as an internal combustion engine, and an electrical generator and rectifier to provide necessary power to a variable electrical load. The system and method operate to meet the demands of the variable electrical load while operating to keep the prime mover at, or near, a specified operating speed.

### FIELD OF THE INVENTION

The present invention relates to a hybrid power system and control method. More specifically, the present invention relates to a hybrid power system and control method wherein each of a prime mover, an electrical generator and a rectifier are controlled, in a substantially stable manner, to provide necessary power to a variable electrical load.

### BACKGROUND OF THE INVENTION

Hybrid power systems are known and are employed in a wide variety of use cases. For example, diesel locomotives employ a diesel internal combustion engine which drives a DC generator and the output of the DC generator is applied to a DC motor which provides motive force for the train. Similar systems are employed in marine environments. More recently, a variety of different hybrid systems have been developed for passenger and commercial road vehicles. For example, Toyota's Hybrid Synergy Drive employs a gasoline internal combustion engine which operates a generator to produce an electric current while also being capable of directly powering the wheels of the vehicle. An electric motor is included in the drivetrain to the wheels and can drive the wheels from electric power supplied by the generator and/or from a set of batteries which are charged from the generator. The system can operate in electric-only (batteries, generator or batteries and generator only), internal combustion engine-only and/or combined electric gas engine modes as desired.

While a variety of other hybrid power systems have been designed, the systems constructed to date are not well suited to all use cases. For example, unmanned aerial vehicles (“UAVs” or “drones”) are commonly battery operated and suffer from the trade-off between battery weight, payload capacity and flight time.

While prior attempts have been made to employ hybrid power systems to replace batteries in such drones, they represent a use case which has proven difficult for hybrid power systems to accommodate. In particular, the electrical current demands of rotary UAV's vary widely, and very quickly, during normal flight operations as the electrically driven rotors are sped up and slowed down to maintain the flight stability of the UAV and any power system must be able to meet these rapidly and widely varying power level requirements.

At the same time, it is desired that the overall weight of the hybrid power system be as low as possible to increase payload capacity and/or flight times and that its operation be fully automated to prevent any additional operating burden on the pilot of the UAV.

To date, it has proven difficult to provide significant electrical current levels, which can vary widely in very short time periods, with an automated system which is light enough and reliable enough for the UAV or other demanding environments.

### SUMMARY OF THE INVENTION

It is an object of the present invention to provide a novel hybrid power system and control method which obviates or mitigates at least one disadvantage of the prior art.

According to a first aspect of the present invention, there is provided a hybrid power system for providing electrical energy to an electrical load, comprising: a prime mover; an electrical generator rotated by operation of the prime mover to produce an AC electrical current output; a DC power bus; an active rectifier operable to rectify the AC electrical current output of the generator to a DC current at a desired amperage and to provide the DC current to the DC power bus; an energy storage device connected to the DC power bus and operating as a buffer to transfer electrical current to and from the DC power bus to meet differences between the DC current output provided by the rectifier and the requirements of the electrical load; and a controller responsive to the electrical current transferred between the energy storage device and the DC power bus to first alter the throttle of the prime mover to maintain the transferred current within a specified amount of a target current and to then alter the operation of the rectifier to change the torque applied to the prime mover by the generator to return the prime mover to within a specified amount of a target operating speed.

Preferably, the target operating speed is determined dynamically. Also preferably, the target for the transferred current is determined dynamically. Also preferably, the prime mover is an internal combustion engine. Also preferably, the generator is at least one three-phase DC brushless motor and the rectifier is a semiconductor bridge rectifier employing pulse width modulated gating signals.

According to another aspect of the present invention, there is provided a method of controlling a hybrid power system supplying electrical power to an electrical load connected to a DC power bus, the hybrid power system including a prime mover connected to an electrical generator operable to produce AC electrical power, an active rectifier operable to convert the produced AC electrical power to DC electrical power supplied to the DC power bus and an energy storage device connected to the DC power bus, the method comprising the steps of: (a) determining the amount of power transferred between the energy storage device and the DC power bus; (b) if the determined amount of power transfer is not within a specified range of a specified level of power transfer, then altering the throttle of the prime mover to bring the amount of power transfer to within the specified range; (c) determining the operating speed of the prime mover; if the determined speed is not within a specified range of a specified operating speed, then altering the operation of the rectifier to change the torque applied to the prime move by the rectifier to bring the operating speed to within the specified range; and (d) repeating steps (a) through (c).

The present invention provides a novel hybrid power system and control method. The system and method controls the operation of each of a prime mover, such as an internal combustion engine, an electrical generator and an active rectifier to provide necessary power to a variable electrical load. The system and method operate to meet the demands of the variable electrical load while operating to keep the prime mover at, or near, a specified target operating speed.

### BRIEF DESCRIPTION OF THE DRAWINGS

Preferred embodiments of the present invention will now be described, by way of example only, with reference to the attached Figures, wherein:

FIG. 1 shows a schematic representation of a hybrid power system;

FIG. 2 shows two control loops employed by the hybrid power system of FIG. 1;

and

FIG. 3 shows a flow chart of a method of implementing the control loops of FIG. 2.

### DETAILED DESCRIPTION OF THE INVENTION

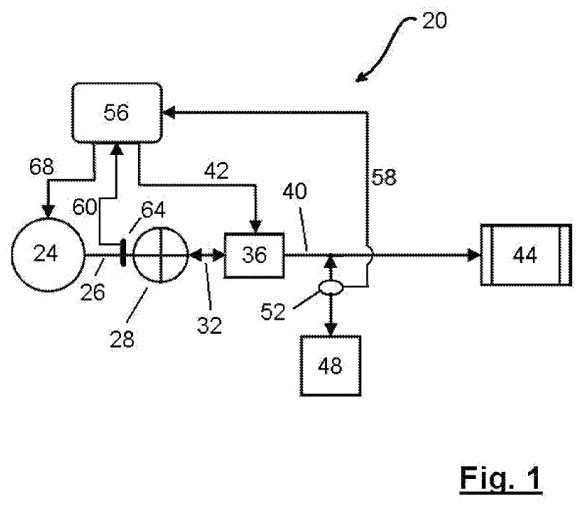

An example of a hybrid power system, in accordance with an embodiment of the present invention, is indicated generally at 20 in FIG. 1. The hardware of system 20 can be similar to that discussed in copending U.S. patent application Ser. No. 16/324,268, which is derived from PCT application PCT/IB2017/054886, filed Aug. 10, 2017 and claiming priority from U.S. provisional patent application 62/372,956 filed Aug. 10, 2016, all of which are assigned to the assignee of this application, and the contents of these applications are included herein by reference. Alternatively, any suitable hardware configuration, as will occur to those of skill in the art, can be employed if desired.

System 20 includes a prime mover 24, such as an internal combustion engine, whose output drive shaft 26 is connected, directly or indirectly (through a transmission or drive linkage, etc), to an electrical generator 28. Prime mover 24 can be any suitable prime mover as will occur to those of skill in the art and suitable examples include two stroke, or four stroke internal combustion engines such as gasoline, diesel or natural gas engines, or gas turbines, etc.

In the specific example of FIG. 1, generator 28 comprises at least one three-phase brushless DC (“BLDC”) motor which, when operated as a generator, produces AC output current 32. As will be apparent to those of skill in the art, generator 28 is not limited to being a BLDC and any other suitable generator type or configuration can be used as desired.

AC current 32 from generator 28 is applied to an active rectifier 36 which converts the AC electrical current to a DC output current which is applied to a DC power bus 40.

In a present embodiment, active rectifier 36 is a MOSFET Bridge rectifier which can rapidly vary its DC output current onto bus 40 independent of the rotational speed of prime mover 24 and generator 28. In particular, as is known to those of skill in the art, active rectification provides improved efficiency over a passive rectifier by replacing diodes with actively controlled switches. Non-limiting examples of these switches include transistors such as MOSFETs or IGBTs and these switches are controlled by pulse width modulation (PWM) signals 42 to their gates in order to achieve rectification and to select the output voltage.

By modulating these pulse width modulated gate signals 42, the output of rectifier 36 can be controlled independently of the operating rotational speed of generator 28 and, as the output of rectifier 36 is varied, the mechanical load (i.e.—the torque) applied to prime mover 24 by generator 28 correspondingly varies.

Also connected to DC power bus 40 is one or more electrical loads 44, such as the drive motors and controllers of the UAV or other vehicle or device that is powered by system 20 and it is expected that the total current requirements of loads 44 can vary significantly during normal operation of the vehicle or device in which system 20 is installed.

An electrical energy storage device 48, which can be a battery, super capacitor, etc. is also preferably connected to DC power bus 40 through a current monitoring device 52 which is operable to measure and report the current flowing in to or out of energy storage device 48 from DC power bus 40.

Amongst other functions, such as providing energy to operate generator 28 as a motor to start prime mover 24, energy storage device 48 provides system 20 with the capacity to meet and accommodate sudden, temporary changes in the energy demands of electrical load 44 during normal operations.

For example, a sudden increased energy demand by load 44 will be met with additional energy supplied from energy storage device 48 to DC power bus 40 until the output at rectifier 36 is sufficient to meet the demand. Once the demand is being met by the output at rectifier 36, energy storage device 48 can be recharged from DC power bus 40.

Similarly, a sudden decrease in the power requirements of electrical load 44 can have the excess power on DC power bus 40 applied to energy storage device 48 until the output at rectifier 36 is again at the required (and in this case, reduced) level.

To achieve the necessary control of system 20, system 20 further includes a controller 56, which can comprise one or more microprocessors and/or microcontrollers and associated circuitry, which operates to control system 20. In particular, as described below, controller 56 is responsive to the difference (“C”) between current supplied to DC power bus 40 from generator 28 and active rectifier 36 and the current drawn from DC power bus 40 by electrical load 44 and the operating speed (“S”) of prime mover 24. In a presently preferred embodiment, current measurement (“C”) is determined by a current monitoring device 52 located between DC power bus 40 and energy storage device 48 which produces a current measurement signal 58. However it is also contemplated that C can be determined by measuring the current flow (positive or negative) between each device connected to DC power bus 40 (i.e.—each device in electrical load 44, as well as the output of generator 36) using appropriate power flow measurement devices.

Controller 56 is also responsive to the operating speed “S” of prime mover 24, as provided by signal 60 from a speed sensor 64. In some embodiments, speed sensor 64 is a sensor directly reporting the RPM speed of the crankshaft of prime mover 24 either by measuring the rotational speed of the crankshaft or by inferring the speed of the crankshaft from other engine control signals, such as the firing of a spark plug, or operating of a fuel injector, etc. and in other embodiments, speed sensor 64 is a discrete, or inherent, part of generator 28 or prime mover 24, such as the output of a crankshaft position determining system, etc.

Whichever implementation is selected, it is preferable, but not essential, that speed sensor 64 can report the speed of prime mover 24 multiple times per engine cycle. In a current embodiment, speed sensor 64 is part of generator 28 and reports the speed of prime mover 24 four or more times per engine revolution.

As described in more detail below, controller 56 operates the throttle (or equivalent mechanism) of prime mover 24 via a control signal 68, as well as provides the pulse width modulated gating signals (or corresponding equivalent control signals) 42 to rectifier 36 to vary the DC output of rectifier 36 onto DC power bus 40, consequently varying the torque (i.e—the mechanical load) applied to prime mover 24.

In the expected use cases for system 20, the weight, size and overall efficiency of system 20 are differently constrained than, for example, in the case of the Toyota HSD, diesel locomotive or marine systems discussed above. In particular, to reduce the overall weight of system 20, prime mover 24 is preferably sized to meet the expected operating parameters of the device into which system 20 is installed with little, if any, excess output capacity. Thus, operation of system 20 often includes operating conditions wherein prime mover 24 is operated at, or near, its maximum rated output capacity. In fact, for some short periods of time, system 20 can even be operated to provide energy in excess of the maximum rated output capacity of prime mover 24 and generator 28 by drawing additional energy from energy storage device 48.

As is well understood by those of skill in the art, operating dynamic systems such as system 20 at, or near, their rated capacity often introduces stability issues such as oscillating outputs, unsafe operations, etc. This is exacerbated when system 20 is used to power electrical loads which are capable of large variations in their requirements, such as when powering the flight systems of rotary UAVs, etc.

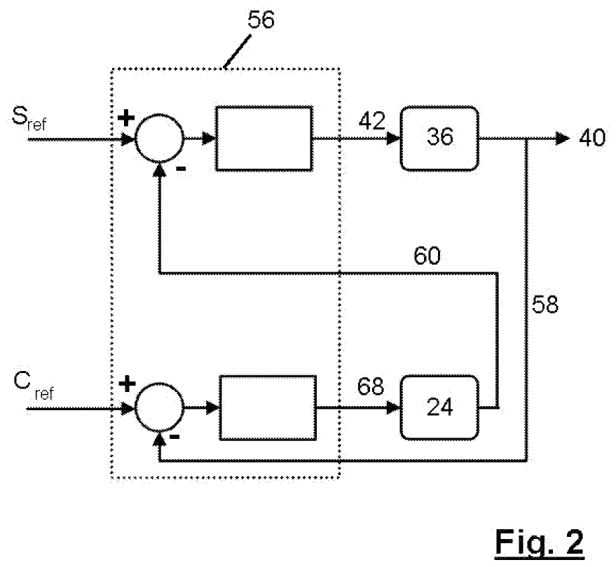

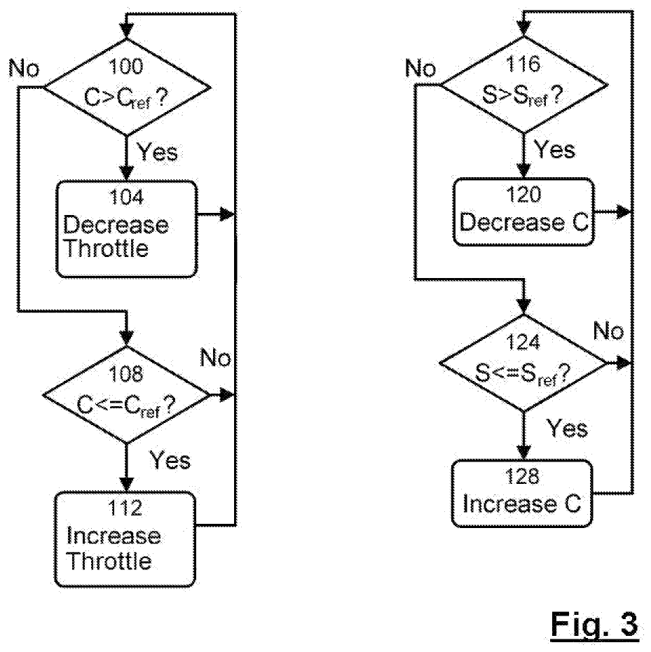

In order to control system 20 in an acceptable and stable manner while still providing acceptable levels of efficiency (power to weight, etc.) controller 56 employs two separate, but inter-related, control loops and this control method is now described with reference to FIGS. 2 and 3.

FIG. 2 shows two of the control loops implemented by controller 56. As shown, controller 56 receives a first control input S_{ref} which represents a desired operating speed for prime mover 24 and a second control input C_{ref} which represents a desired current difference (typically a positive value between the power drawn from DC power bus 40 and that produced by generator 28). In the embodiment of FIG. 1, this desired current difference is measured at current sensor 52. As will be discussed further below, S_{ref} and C_{ref} can be static values, selected, for example, for fuel and/or operating efficiency, or can be dynamically varied values, to accommodate various operating conditions of system 20.

If static, S_{ref} can be selected to be a desired operating speed at which prime mover 24 exhibits: good fuel economy; reduced vibration; reduced noise; or enhanced operating lifetime; etc. Similarly, if C_{ref} is static and energy storage device 48 is a battery, C_{ref} can be selected to provide an appropriate “trickle charge” current to energy storage device 48. Conversely, if energy storage device 48 is a super capacitor, than a static setting for C_{ref} could be a zero current.

The control loops of FIG. 2 relate to the operation of system 20 in normal operating conditions, i.e.—after startup, warmup, etc. of system 20. The method of operating system 20 through such startup and other conditions can be achieved in a variety of manners and will be apparent to those of skill and will not be described hereinafter in further detail.

In normal operating conditions, controller 56 operates to maintain the speed S of prime mover 24, as indicated by signal 60, at a value acceptably close to S_{ref} (i.e. S=S_{ref}±an allowed variation value). Similarly, controller 56 operates to maintain the output of rectifier 36 such that the power supplied to DC power bus 40 is closely matched to the power requirements of electrical load 44, so that the current C into or out of energy storage device 48, as indicated by signal 58, is acceptably close to C_{ref} (i.e. C=C_{ref}±an allowed variation value).

As will be apparent, the two control loops of FIG. 2 are inter-related by the physical arrangement and limitations of system 20. In particular, a change in the operating speed of prime mover 24 will result in a change of output generator 28, with an increase in speed of prime mover 24 resulting in a corresponding increase in the output of generator 28 and a decrease in the operating speed of prime mover 24 resulting in a corresponding decrease in the output of generator 28. Similarly, rectifier 36 can be configured (via changing the pulse width modulated gating signals applied to it) to increase its output by increasing the torque (i.e.—load) it applies to prime mover 24 (via generator 24) or to decrease its output by decreasing the torque it applies to prime mover 24. As will also be apparent, changes to the configuration of rectifier 36 can be achieved much faster than changes to the speed of prime mover 24 can be effected.

The control method preferably commences with controller 56 first determining if system 20 is in a normal operating state, e.g. prime mover 24 is operating, current is being produced by generator 28, rectifier 36 is operable etc. If system 20 is in a normal operating condition, then the method proceeds to step 100 as described below with reference to FIG. 3. Conversely, if controller 56 determines that system 20 is not in a normal operating state, controller operates to place system 20 into a normal operating condition or to appropriately handle any error conditions encountered. The specific startup and/or error handling operations will be apparent to those of skill in the art and are not discussed further herein.

If system 20 is in a normal operating condition, the method proceeds at step 100 as shown in FIG. 3. At step 100, controller 56 determines if the current C, between DC power bus 40 and energy storage device 48, as determined by sensor 52, is greater than the reference current C_{ref}.

If it is determined that C>C_{ref}, then the method proceeds to step 104 wherein controller 56 reduces the throttle of prime mover 24, by a selected amount, by altering control signal 68. The amount by which the throttle of prime mover 24 is altered can be pre-selected (based upon prior empirical testing of system 20 or any other suitable strategy to determine a suitable value for the resulting speed change) or can be dynamically determined, for example via a predefined lookup table containing values corresponding to the magnitude by which C exceeds C_{ref}. In a present embodiment, the value by which the throttle (or equivalent) of prime mover 24 is altered is pre-determined.

When the throttle of prime mover 24 has been adjusted at step 104, the method returns to step 100.

If at step 100 it is determined that C is not greater than C_{ref}, then the method proceeds to step 108 wherein it is determined if C<=C_{ref}. If at step 108 it is determined that C is less than, or equal to, C_{ref}, then the method proceeds to step 112 wherein controller 56 increases the throttle of prime mover 24 by appropriately altering control signal 68 and the method returns to step 100. Again, the amount by which the throttle of prime mover 24 is altered can be pre-selected (based upon prior empirical testing of system 20 or any other suitable strategy to determine a suitable value for the resulting speed change) or can be dynamically determined corresponding to the magnitude by which C is less than C_{ref}. In a present embodiment, the value by which the throttle of prime mover 24 is altered is predetermined.

If at step 108 it is determined that C is not less than, or equal to, C_{ref} the method returns to step 100.

Simultaneously, while the first control loop comprising steps 100 through 112 is being executed by controller 56, the second control loop comprising steps 116 to 128 is also being executed by controller 56.

Specifically, at step 116 controller 56 determines if the speed S of prime mover 24, as indicated by signal 60, is greater than S_{ref}. If it is, then the method proceeds to step 120 wherein rectifier 36 is configured to reduce its output (by appropriately altering the pulse width modulated gating signals 42 applied to rectifier 36) and hence reduce C—resulting in a decrease of the torque/load applied to prime mover 24 by generator 28. The amount by which the output of rectifier 36 is altered can, like the amount by which the speed of prime mover 24 is altered, be a preselected amount, be a preselected amount or can be dynamically determined by any suitable means, as will occur to those of skill in the art. The method then returns to step 116.

If, at step 116 controller 56 determines that S is not greater than S_{ref}, then the method proceeds to step 124 wherein controller 56 determines if S is less than or equal to S_{ref}. If S is less than or equal to S_{ref} then the method continues at step 128 wherein controller 56 increases the output of rectifier 36 (increasing the load/torque applied to prime mover 24 by generator 28) by appropriately altering signals 42 and the method returns to step 116. Again, the amount by which the output of rectifier 36 is altered can be a preselected amount or can be dynamically determined by any suitable means.

If at step 124 S is not less than or equal to S_{ref}, then the method returns to step 116.

Thus, as should now be clear, the operating speed of prime mover 24 is controlled by altering the torque applied to it by generator 28, via altering the operation of rectifier 36, and the output current of generator 28 and rectifier 36 is controlled by altering the throttle of, and thus the torque produced by, prime mover 24.

As mentioned above, controller 56 executes both the first loop (comprising steps 100 to 112) and the second loop (comprising steps 116 to 128). However, it should be apparent to those of skill in the art that each of the first and second loops can be executed at different rates. In particular, as the output of rectifier 36 can be altered much faster than the effects of changing the throttle of prime mover 24 will affect the operation of prime mover 24, it is contemplated that the second loop (i.e.—steps 116 through 128) can be repeated more often than the first loop (i.e.—steps 100 through 112). For example, the first loop operating to control the throttle of prime mover 24 may be executed once per firing cycle of prime mover 24 while the second loop, operating to regulate the output of rectifier 36, can be executed four, or even eight or more, times per firing cycle of prime mover 24.

In typical use controller 56 will execute the first and second loops such that controller 56, in response to changes in electrical load 44, first adjusts the throttle of prime mover 24 and then adjusts the output of rectifier 36. Typically, the output of rectifier 36 will be adjusted multiple times for each adjustment made to the throttle of prime mover 24.

When electrical load 44 increases, controller 56 determines the decrease in current C (which can, in fact, go negative as energy storage device 48 discharges to meet the increased load) and increases the throttle, and thus torque produced by prime mover 24, increasing the operating speed S of prime mover 24.

By increasing speed S of prime mover 24, the output at rectifier 36 is correspondingly increased and current C increases. Next, controller 56 increases the output of rectifier 36, increasing the load (torque) applied to prime mover 24 by generator 28 and thus decreasing the speed S of prime mover 24. Depending on the determined values of S and C, controller 56 may apply multiple increases to S and to C to accommodate the increase in electrical load 44.

Similarly, when electrical load 44 decreases, controller 56 determines the increase in current C to electrical storage device 48 and decreases the throttle of prime mover 24 to match the reduced electrical needs of load 44. Controller 56 then decreases the output of rectifier 36 to reduce the load/torque applied to prime mover 24 by generator 28. Again, depending on the determined values of S and C, controller 56 may apply multiple decreases to S and to C to accommodate the increase in electrical load 44.

As will now be apparent, system 20 operates such that, as the power requirements of load 44 change, perhaps very rapidly, those requirements are served by DC power bus 40 which is, in turn, supplied by the output of rectifier 36 and generator 28 in combination with energy storage device 48. Energy storage device 48 temporarily accommodates differences between the requirements of load 44 and the output of rectifier 36 and generator 28, acting much like a buffer.

Controller 56 performs the method described above to adjust operation of system 20 to closely match the output of rectifier 36 and generator 28 to the power requirements of electrical load 44 by first altering the throttle of prime mover 24 (and thus the output of generator 28) to substantially match the power requirements of electrical load 44, and then by adjusting the operation of rectifier 36 (and thus the torque applied to prime mover 24) to return the operating speed of prime mover 24 to a point acceptably close to a desired operating speed.

By first adjusting the throttle and thus the operating speed of prime mover 24 and then subsequently adjusting the torque applied to prime mover 24 by rectifier 36, the differences in the speed with which the operating parameters of prime mover 24 and rectifier 36 can be varied are safely accommodated. Specifically, it will be apparent that the speed with which changes to the gating signals to rectifier 36 result in changes in the torque applied to prime mover 24 greatly exceeds the speed with which changes to the throttle of prime mover 24 will result in corresponding changes in its torque production and hence its operating speed.

With the method described herein, potentially catastrophic or problematic failure modes of system 20 can be avoided, for example in the case wherein rectifier 36 would otherwise be signaled to produce a significantly increased output, to meet a sudden increase in electrical load 44. If the operation of rectifier 36 is altered to produce the increased required power before, or even substantially simultaneously, with prime mover 24, rectifier 36 could apply sufficient torque to prime mover 24 to stall prime mover 24 before prime mover 24 can appropriately respond to an increase in its throttle. Those of skill in the art will easily envision other failure (or undesirable) operating modes which could otherwise occur.

The above-described method for controlling system 20 has been designed in view of the fact that the mechanical inertia of prime mover 24 greatly exceeds the “electrical inertia” of rectifier 36. In other words, changes to the load on prime mover 24 from rectifier 36 (and generator 28) have effect much more quickly than prime mover 24 can react to changes to its throttle (or equivalent mechanism). Thus, the method first adjusts the throttle of prime mover 24 before adjusting the output of rectifier 36.

As mentioned above, energy storage device 48 operates as a “buffer” to deal with differences between the output of rectifier 36 and the requirements of electrical load 44 as the speed of prime mover 24 and the output of rectifier 36 are varied. Ideally, the implementation of controller 56, the design of prime mover 24 and the magnitude of the adjustments to S and C are all selected to reduce the magnitude of the variations between the power of DC bus 40 and the power requirements of electrical load 44, such that the capacity (and mass) of energy storage device 48 is no larger than required for system 20.

As mentioned above, controller 56 operates the throttle of prime mover 24 to produce the torque necessary to maintain the operating speed S of prime mover 24 at, or near, a reference value S_{ref}. It is contemplated that in some circumstances S_{ref} will be a static value, pre-selected to meet appropriate parameters, such as an operating speed selected for good operating fuel efficiency, etc. However, it is also contemplated that in other circumstances, S_{ref} can be a dynamic value.

For example, prime mover 24 may have a first operating speed, providing good fuel efficiency, when serving light output loads and a second operating speed providing good fuel efficiency when serving heavier loads. Similarly, prime mover 24 may have a first operating speed at which it operates fuel-efficiently at sea level and a second operating speed at which it operates fuel-efficiently at altitudes 3,000 feet or more above sea level.

In such cases, controller 56 can employ different, and appropriate, values for S_{ref} and these values can be obtained from a predetermined lookup table, determined dynamically by controller 56 from inputs 58 and 60 or selected or determined in any other appropriate manner as would apparent to those of skill in the art.

Similarly, controller 56 operates to maintain the current flow between energy storage device 48 and DC power bus 40 at, or near, a reference value C_{ref}. It is contemplated that in some circumstances C_{ref} can be an appropriate static value (i.e.—a value representing a “trickle charge current”). However, it is also contemplated that C_{ref} can be a dynamic value. For example, in a current embodiment of system 20, energy storage device 48 supplies energy to generator 28, which operates as a motor, to start prime mover 24. In this case, it is desired to replace the (possibly significant) amount of energy which was removed from energy storage device 48 by the starting operation. Accordingly, in this case C_{ref} can be set to an appropriate current level, higher than a value used during normal, steady state, operations, to quickly recharge energy storage device 48 and, once energy storage device 48 has been sufficiently recharged (which can be determined in any suitable manner), C_{ref} can be set to a lower, above-mentioned trickle charge level or any other appropriate level.

Similarly, as mentioned above energy storage device 48 serves as a buffer to meet shortfalls between the produced energy and the energy required by the load and to absorb excess energy from DC power bus 40. Under normal operating conditions controller 56 can monitor the energy flow into and out of energy storage device 48 to determine the charge state of energy storage device 48 on an ongoing basis. In such a case, controller 56 will dynamically set C_{ref} to appropriate levels to ensure that energy storage device 48 is properly charged and is not overcharged.

The present invention provides a novel hybrid power system and control method. The system and method controls the operation of each of a prime mover, such as an internal combustion engine, and an electrical generator and rectifier to provide necessary power to a variable electrical load. The system and method operate to meet the demands of the variable electrical load, while operating to keep the prime mover at, or near, a specified operating speed.

The above-described embodiments of the invention are intended to be examples of the present invention and alterations and modifications may be effected thereto, by those of skill in the art, without departing from the scope of the invention which is defined solely by the claims appended hereto.

We claim:

1. A hybrid power system for providing electrical energy to an electrical load, comprising:
a prime mover;
an electrical generator rotated by operation of the prime mover to produce an AC electrical current output;
a DC power bus;
an active rectifier operable to rectify the AC electrical current output of the generator to a DC current output at a desired amperage and to provide the DC current output to the DC power bus;
an energy storage device connected to the DC power bus and operating as a buffer to transfer electrical current to and from the DC power bus to meet differences between the DC current output provided by the rectifier and the requirements of the electrical load; and
a controller responsive to the electrical current transferred between the energy storage device and the DC power bus to first alter the throttle of the prime mover to maintain the transferred current within a specified amount of a target current and to then alter the operation of the rectifier to change the torque applied to the prime mover by the generator to return the prime mover to within a specified amount of the target operating speed.

2. The hybrid power system of claim one wherein the prime mover is an internal combustion engine.

3. The hybrid power system of claim 1 wherein the generator is at least one three-phase brushless DC motor.

4. The hybrid power system of claim 3 wherein the active rectifier is semiconductor bridge rectifier controlled by pulse width modulated gating signals.

5. The hybrid power system of claim 1 wherein the throttle is altered by predefined amounts.

6. The hybrid power system of claim 1 wherein the target operating speed is determined dynamically.

7. A method of controlling a hybrid power system supplying electrical power to an electrical load connected to a DC power bus, the hybrid power system including a prime mover connected to an electrical generator operable to produce AC electrical power, an active rectifier operable to convert the produced AC electrical power to DC electrical power supplied to the DC power bus and an energy storage device connected to the DC power bus, the method comprising the steps of:
(a) determining the amount of power transferred between the energy storage device and the DC power bus;
(b) if the determined amount of power transfer is not within a specified range of a specified level of power transfer, then altering the throttle of the prime mover to bring the amount of power transfer to within the specified range;
(c) determining the operating speed of the prime mover; if the determined operating speed is not within a specified range of a specified operating speed, then altering the operation of the rectifier to change the torque applied to the prime move by the rectifier to bring the operating speed to within the specified range; and
(d) repeating steps (a) through (c).

8. The method of claim 7 wherein the specified operating speed of the prime mover is determined dynamically.

9. The method of claim 7 wherein step (c) is performed at a greater rate than step (b).

10. The method of claim 7 wherein the specified level of energy transfer is determined dynamically.
